(19) United States
(12) Patent Application Publication
(10) Pub. No.: US 2023/0055076 A1
(43) Pub. Date: Feb. 23, 2023

(54) Trek Rod Engageable Support

(71) Applicants: Drew Miles, II, El Cajon, CA (US); Paul Tarpy, Santee, CA (US); Broc Kelly, El Cajon, CA (US)

(72) Inventors: Drew Miles, II, El Cajon, CA (US); Paul Tarpy, Santee, CA (US); Broc Kelly, El Cajon, CA (US)

(21) Appl. No.: 17/876,287

(22) Filed: Jul. 28, 2022

Related U.S. Application Data
(60) Provisional application No. 63/226,596, filed on Jul. 28, 2021.

(51) Int. Cl. F16M 13/08; F16M 11/16; F16M 11/24; A45B 3/14; A45B 3/00

(52) U.S. Cl. CPC F16M 13/08; F16M 11/16; F16M 11/242; A45B 3/14; A45B 3/00; A45B 2200/05; F41A 23/08

(57) ABSTRACT

A trek pole engageable support system is provided allowing users to form a support for a camera, firearm, or other object needing steady positioning. A body of the support has at least one support member engaged at a first end which is configured to compressibly engage the distal end of a support pole at a second end. So engaged with a support pole the body provides elevated support to the object being supported.

This application claims priority to U.S. Provisional Patent Application Ser. No. 63/226,596 filed on Jul. 28, 2021, which is incorporated herein in its entirety by this reference thereto.

### BACKGROUND OF THE INVENTION

### 1. Field of the Invention

The invention herein disclosed relates generally to elevated steady supports employed for cameras and optical components and firearms. More particularly, it relates to a support configured with connectors adapted to removably engage to the distal end of trek rods or hiking sticks or ski poles and the like.

### 2. Prior Art

### Background of the Invention

Hiking has been an enjoyable pastime throughout the world. Whether it be a day hike or a long trek for days or weeks, hikers conventionally carry with them supplies and the like, which may be needed.

Because hiking requires the person to carry with them both the bare requirements, such as food and water, as well as other items, such as bedding and tents, it has become important that supplies and components carried by hikers be light weight. Indeed, every extra pound carried by a hiker over a duration of a day or weeks must be supported by the body of the hiker while walking from point to point. Consequently, it has become very important for hikers to carry the minimum amount of supplies and gear needed for the duration of their trek. Further, it is additionally important, where the outing will take multiple days, to minimize the weight of the supplies being carried and thereby minimize the resulting energy required by the hiker to do so.

With respect to the above, before explaining at least one preferred embodiment of the pole engageable support system herein, it is to be understood that the system invention is not limited in its application to the details of employment and to the arrangement of the components or the steps set forth in the following description or illustrated in the drawings. The various components and configurations herein disclosed for the pole engageable support, are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based, may readily be utilized as a basis for other trek pole and ski pole engageable support systems. It is important, therefore, that the embodiments, objects and claims herein, be regarded as including such equivalent construction and methodology insofar as they do not depart from the spirit and scope of the present invention.

### SUMMARY OF THE INVENTION

The disclosed device and system herein provides a support having a body which is adapted for engagement to, or support of, a variety of components on one or a first surface while being engageable on an opposing side or second surface to collapsible poles. An upper or first surface of the body of the device is adapted to engage with optical components such as a camera or telescope or binoculars. The upper surface of the body is also configured to support the underside of a firearm to aid in holding it steady or to other optical or scientific components or the like which operate in a preferred mode using fixed support.

Extending from the body portion of the device are at least one and preferably a plurality of support members. These support members are configured to removably engage with the distal end of one or a plurality of trek poles. By trek poles herein is meant the fixed or telescopic poles conventionally employed by hikers, or walking sticks or ski poles and the like, or similar poles having a gripping handle on a first end and a tip at the opposite distal end. Such trek or other poles conventionally are frequently carried by people engaged in hiking and other sports and by explorers.

Each support member is configured with a first end in an engagement with the support body and so engaged extends to a second end thereof. Each support member is preferably configured with an axial passage running therein which communicates with an opening at the second end of the support member. Each such opening at the second end of each respective support member is configured with a compressive connector for forming removable engagement or positioning on the distal end of a trek pole therein in a compressive engagement thereon. By compressive connector forming a compressive engagement herein is meant that a distal end of a trek pole, inserted into the opening at the second end of the support member, has the exterior surface of the distal end engaged in a biased contact with internal surfaces located within the opening. By progressive compressive engagement is meant that the biased contact can be increased through adjustments actuated by the user which cause an increase in such a compressive engagement.

In a preferred mode of the device and system herein each support member also includes a compression engaging connector which operates to impart an initial compressive connection and thereafter, a progressively stronger compressive connection upon the exterior surface of the distal end of the trek pole when that distal end is inserted into the opening at the second end of the support member. While the device may operate without such a connection, in experimentation, it was found that such a compressive connection is preferred to prevent slippage of the distal end of the trek pole while it is positioned through the opening and into the axial passage. Such slippage was found to allow movement of the overhead body which is not desirable, for example, when target shooting or capturing photographs.

Currently, one favored mode of a compressive connector, providing a compressive connection due to simplicity, is provided by a collar positioned around the exterior circumference of the support member. The collar is operatively engaged to threads positioned on the exterior circumference of the support member. In this threaded engagement, rotation of the collar in either of two directions will cause it to engage or disengage from the compressive connection to a trek pole distal end. This mode also allows the device to compressibly engage either linear or tapered distal ends of trek poles with a compressed engagement which is most important due to the varying sizes from various manufacturers.

This collar operatively surrounds a splined section of the support member formed as part of or extending from the support member. The axial passage of the support member aligns with and extends into and through the splined section to the opening at the second end of the support member. The splined section has at least one and preferably a plurality of gaps formed in a sidewall, defining the splined section. These gaps extend to and are positioned around the opening at the second end of the support member.

In operation, once the user inserts the distal end tip of a trek pole or the like through the opening and into the axial passage of each support member, the collar may be rotated in a first direction upon the threads to which it is engaged. As the threadably engaged collar rotates in the threaded engagement and moves in this first direction toward the second end of the support member, such movement causes an inward deflection of portions of the sidewall of the splined section toward the center axis of the support member which runs centrally through the axial passage. This deflection reduces the interior circumference of the axial passage of the support member and serves to impart a compressive contact of interior surfaces of the portions of the splined section in between the gaps, toward the center axis of the axial passage. The deflection causes a compressive contact against the distal end of the trek pole inserted into the axial passage. In the threaded engagement, as the collar is rotated further in the first direction, it causes an increase in the inward deflection and thereby imparts an increased compressive contact and engagement against the exterior of the inserted distal end of the trek pole.

Such a compressive connecter, providing the compressive engagement, might also be provided by a spring engagement of a plurality of contacts or spring engaged splined sections within the axial passage to provide a compressive contact. However, the employment of the collar to deflect the splined sections of the sidewall is preferred. This is because, in experimentation, it was found that such a collar imparting inward deflection and compressive contact was not overly impaired by mud, snow, ice, water and other contaminants which a user might encounter when hiking or exploring. However, these contaminants will impair or disable spring loaded and other modes of imparting compression against an inserted trek pole end. As such, the threaded collar mode of imparting compressive engagement and/or adjustable increasing compressive engagement is preferred, since such is not easily disabled.

While the device will function without the simple insert of the poles into the axial passage for support, including a compressive contact is preferred in all modes herein as it minimizes or eliminates rotation of the distal end of each trek pole while removably positioned within an axial passage. The compressive contact also eliminates any axial sliding of the distal end of the trek pole positioned within the axial passage. Such slippage can result in rotation of the body, while supported on two trek poles during use, and elimination of such is preferable.

The device will function to support a camera or optical component or firearm or other component needing a steady positioning during use, through the inclusion of an engaging component on the upper side of the body. A camera, for example, can be engaged to the upper or first surface using a threaded pin, as may a telescope or binoculars. A firearm support is provided by simple support thereof on the upper surface or by the provision of a firearm engagement to the threaded pin to position the underside of a chosen firearm thereon also.

While a single pole compressibly engaged into a single support member, extending from the support body, will enhance stability of a supported item, it is preferable to provide at least two support members. Where two or more support members are provided, each is preferably removably compressibly engageable within a respective axial passage, with a respective distal end of a trek pole. The employment of two such trek poles will provide the user an enhanced steady positioning of the support body by better resisting tilting of any camera, optical device, firearm, or other item supported thereby.

The device, thus, provides a very steady support for the user to employ in a lightweight and compact configuration, since no legs are required, because it employs the trek poles already carried by the user for that purpose. It eliminates the need for the user to bring a tripod and the extra weight and volume during packing such would require.

With respect to the above description, before explaining at least one preferred embodiment of the pole engageable support system herein, it is to be understood that the invention is not limited in its application to the details of operation nor the arrangement of the components or the steps set forth in the following description or illustrations in the drawings. The various methods of implementation and operation of the device herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other devices for carrying out the several purposes of the disclosed pole engageable support system herein. Therefore, that the objects and claims herein should be regarded as including such equivalent construction, steps, and methodology insofar as they do not depart from the spirit and scope of the present invention.

It is an object of this invention to provide a lightweight and portable support for elevated steady positioning of a camera, optical device, firearm or other components which function better with such support.

It is a further object of this invention to provide such a support which requires no elongated members itself for such support and employs hiking or trek poles as the support legs to thereby minimize the weight and stored volume of the device.

These together with other objects and advantages, which become subsequently apparent reside in the details of the construction and operation of the system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 depicts a side view of the device showing the support body having a plurality of support members extending from respective engagements to the body portion thereof.

FIG. 2 shows a lower view of a plurality of support members extending from engagements to the body and shows the axial passage within each support member which is surrounded by a collapsible splined compression section.

FIG. 3 shows a sectional view through a support member having a compressive connector formed by an axial passage running axially therein which communicates with the opening at the second end of the support member though the splined section surrounded by the threadably engaged collar.

FIG. 4 shows a compressive connector having a collar engaged upon the support member which is engageable with a threaded portion on the exterior surface of the support member wherein rotation toward the open end will compress portions of the splined section to form a compressed engagement against an inserted trek pole end.

FIG. 5 depicts the device having three support members extending from a lower or second side of the body each of which are configured to form a compressible engagement with the tip or distal end of a trek pole.

FIG. 6 shows an exploded view of the device showing the distal ends of a pair of trek poles being tapered which will become compressibly engaged within respective axial passages of the pair of support members.

FIG. 7 shows the device, as in FIG. 6, wherein the points or distal ends of the two trek poles have been removably compressibly engaged within the axial passages of a respective support member by the respective compressive connector on each support member.

FIG. 8 shows another mode of the device herein having a pair of support members operatively connected at the first end to a body.

FIG. 9 depicts the device herein in an as-used positioning showing the body removably engaged with and supported by a pair of trek poles and providing steady support for a firearm on the upper or first surface of the body portion.

### DETAILED DESCRIPTION OF THE PREFERRED

### Embodiments of the Invention

In this description, the directional prepositions of up, upwardly, down, downwardly, front, back, top, upper, bottom, lower, left, right and other such terms refer to the device as it is oriented and appears in the drawings and are used for convenience only. Any such terms are not intended to be limiting or to imply that the device has to be used or positioned in any particular orientation.

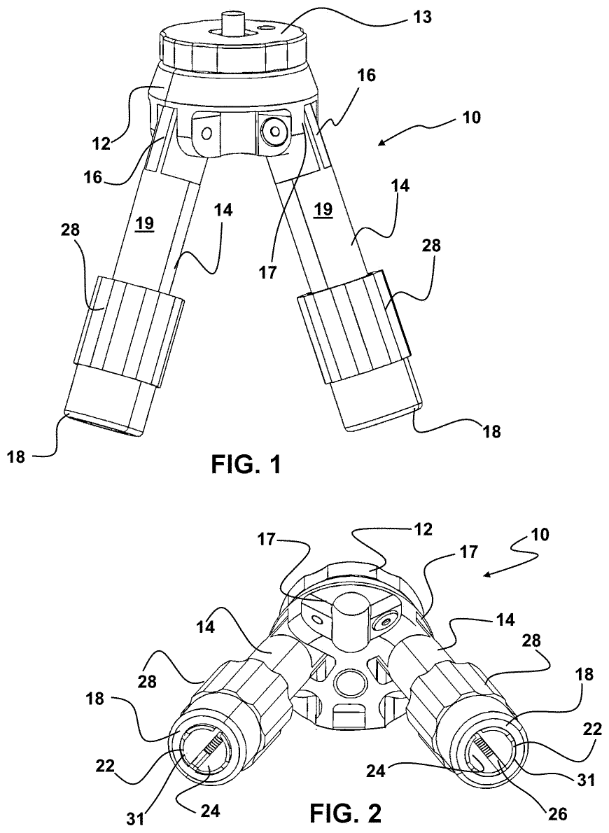

Referring now to the trek pole engageable device 10 herein, shown in the depictions of FIGS. 1-9, there is seen in FIG. 1 a side view of the device 10 showing a support body 12 and a first or upper surface 13 thereof. The support body 12 has at least one, and preferably a plurality, of support members 14 engaged thereto.

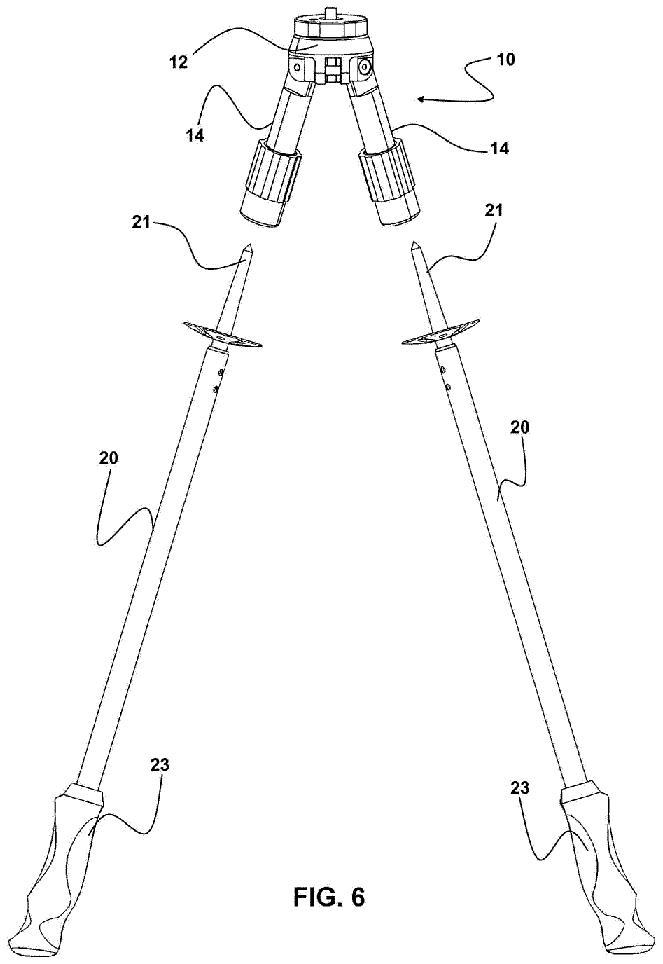

Each support member 14 extends from an engagement of a first end 16 thereof to the support body 12. While the engagement may be on sides or other surfaces of the support body 12, as shown, such an engagement may be to the lower or second surface 11 of the body 12, whereupon the support member extends to a second end 18. As noted, each support member 14 is configured at the second end with a compressive connector which forms a compressive engagement with the distal end of a trek pole 20 opposite the handle end thereof, such as is shown in FIG. 6.

It is preferred that the support members 14 are in a pivoting engagement 17 with the support body 12. This is because such a pivoting engagement 17 allows the user to rotate the support members 14 outwardly away from the center of the support body 12 and thereby achieve a supporting angle for the support members 14 and any trek pole 20 removably engaged thereto, which imparts a much more stable positioning of the support body 12.

In FIG. 2 is depicted the device 10 from a lower or second surface view. As shown, the plurality of support members 14 have sidewalls 19 which extend to respective second ends 18 thereof. At the second ends 18 are openings 22 which communicate with an axial passage running axially within the sidewall 19 of each support member 14.

Also shown, a mode of the compressive connector is provided by splined sections 24 having gaps 26 formed through the sidewall 19 in the area forming the splined sections 24. The splined sections 24, as noted above, will collapse slightly when the collar 28, which is threadably engaged on threads 29 formed on the exterior of the sidewall 19 of the support member 14, is rotated. Such rotation, in one direction, causes the threads 29 in the collar 28 to move along their engagement to the threads 29 on the support member 14 and toward the second end 18 of the support member 14. The movement during rotation of this threaded engagement causes the interior surface 31 or circumference of one end of the collar 28 to contact against the sidewall 19 and the splined sections 24, thereby causing the inward movement thereof.

This splined section 24 configuration, with inward movement imparted by the interior surface 31 of the collar 28, is particularly preferred in that, in experimentation, it was shown to provide a compressed engagement of the splined sections 24 against a distal end 21 (FIG. 6) of a trek pole 20, whether that distal end is formed constant or linear or is tapered. Further, the rate of taper of trek poles 20 from different manufacturers was also accommodated and a secure compressed engagement of the splined sections 24 thereagainst was achieved, irrespective of the rate of taper or narrowing of the distal ends 21.

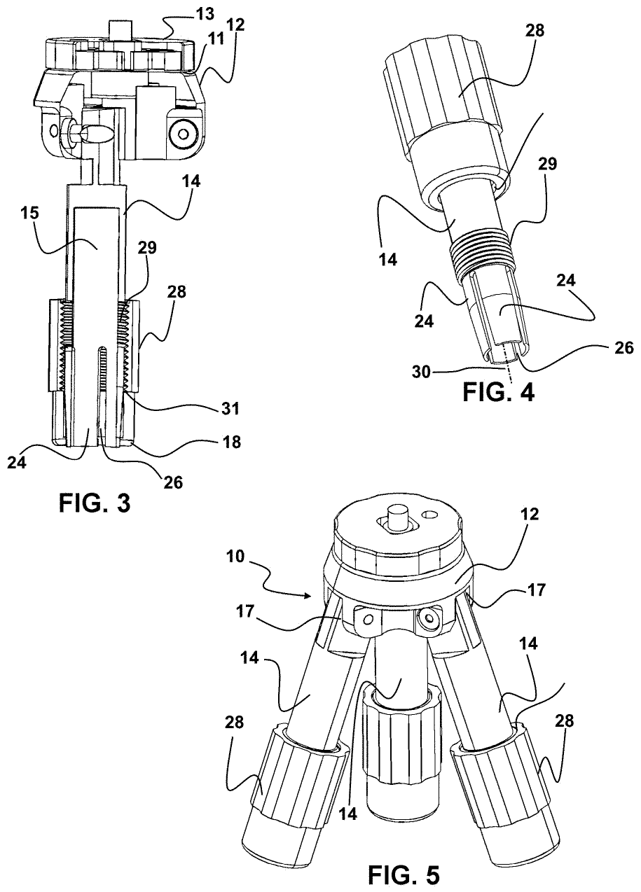

Shown in FIGS. 3-4 are views of a support member 14 surrounding the axial passage 15 therein engaged in a pivoting engagement 17 to the body 12 at a first end thereof. As can be seen, a compressive connector is provided, using threads 29 on the collar 28 threadably engaged with threads 29 on the exterior of the sidewall 19 of the support member 14. When the collar 28 is rotated in this engagement, in a direction to move toward the second end 18, the interior surface 31 contacts the sidewall and against the splined sections 24. Such contact deflects the splined sections 24, situated in between the gaps 26, toward the center axis 30 running through the center of the axial passage 15.

This deflection forms the compressive connection through the compressive contact of the splined sections 24 against the exterior surface of the distal end 21 of the trek pole 20 or pole shown in FIG. 6. The ability to continually increase the deflection of the splined sections 24, by continuing the rotation of the collar 28, provides for an adjustable increase or decrease in the compressive biasing pressure upon the distal ends 21. This function, allowing increasing of deflection of the splined sections 24, also allows each respective support member 14 to adjust to and compressibly engage varying sized distal ends 21 of differing trek poles 20, which is most important.

In another mode of the device 10, the splined sections 24, which deflect, may be on a pivot or formed to deflect on an angle such that a slanted or narrowing second end 18, which tapers, can be engaged substantially fully in an increased contact. Of course, other compressive engagements with the distal ends 21 of the trek poles 20 may be employed as would occur to those skilled in the art, such as springs on contacting members, and such are anticipated within the scope of this application. However, currently, the collar 28 is preferred as it allows for adjustment and varying the force of compression and will allow for deflection of the splined sections 24 to accommodate a larger number of pole 20 distal ends 21 of differing dimensions.

As depicted in FIG. 5, the device 10, as noted, may be provided with as few as one support member 14 and as many as three or more support members 14. Two support members 14 are currently preferred for a lightweight version of the device 10 as such provides a more steady support than a single support member 14 and has less weight and volume than a device 10 with three support members 14.

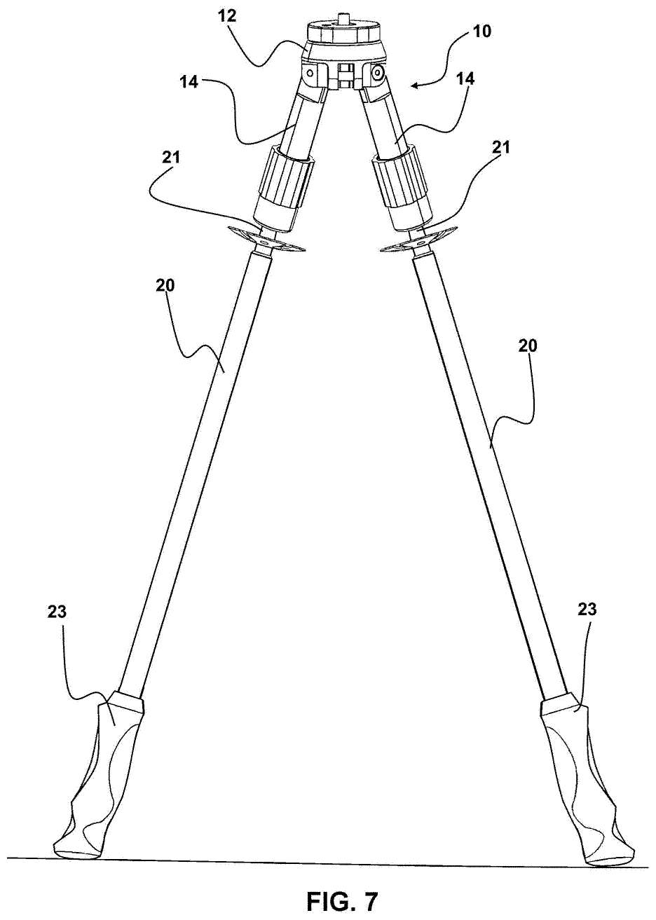

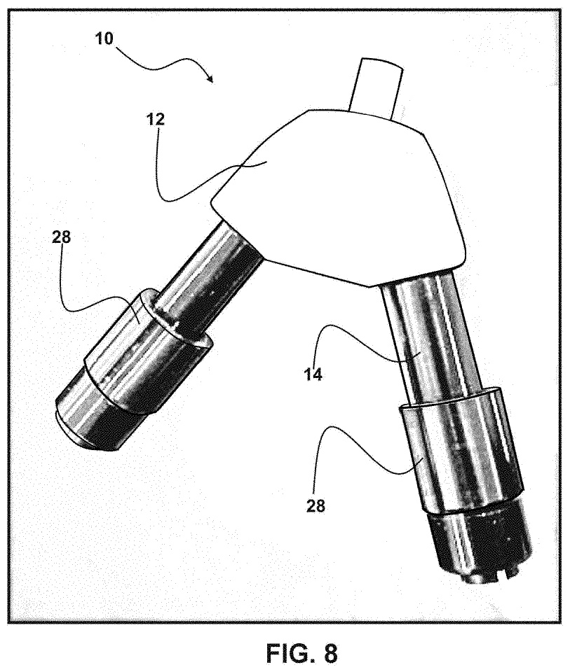

As noted above, FIGS. 6-7 depict the device 10 and its configuration being positioned in a removable engagement to trek poles 20 or poles or the like which have a handle end 23 opposite a distal end 21 which is conventionally narrowed or tapered on many such poles. As shown, to employ the device 10, a user will align the trek poles 20 with the axial passages of each support member 14 and insert the distal end 21 therein. Thereafter, the collar 28 will be rotated in its threaded engagement to removably compress the splined section 24 against the distal ends 21 of the pole 20. Removal would be in reverse order. Each collar 28 can be rotated in a respective threaded engagement to achieve more or less of a compressive contact of the respective support member 14 with the chosen trek pole 20.

In FIG. 8, the device 10 is shown with a body 12 having a more linear configuration and having fixed rather than pivoting engagements of the respective support members 14. While lacking the function of angling the support members 14 for more secure positioning, the device 10 does provide for compact transport and the use of trek poles for support.

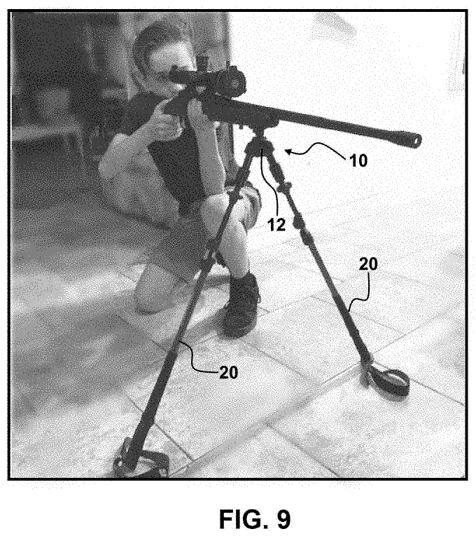

FIG. 9 depicts the device 10 herein in an as-used positioning, showing the body 12 removably engaged with and supported by a pair of trek poles 20 and providing steady support on the upper or first surface 13 for the underside surface of a firearm. Such yields an easy to transport support for target shooting of fire arms.

While all of the fundamental characteristics and features of the trek pole engageable support have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A trek pole engageable support apparatus, comprising:
a support body having an upper surface opposite a lower surface;
said upper surface configured for support of an object thereon
at least one support member in an engagement at a first end thereof to said support body;
said support member having a sidewall surrounding an axial passage therein;
an opening at a second end of said support member communicating with said axial passage;
said opening for insertion of a distal end of a support pole therethrough and into said axial passage; and
said second end of said support member having a compressive connector thereon for forming a removable compressive engagement with said distal end of said support pole.

2. The trek pole engageable support apparatus of claim 1 wherein said compressive connector comprises:
a collar in a threaded engagement upon an exterior surface of said sidewall, said collar moveable along said threaded engagement in a first direction toward said second end of said support member and in a second direction opposite said first direction;
splined sections of said sidewall surrounding said opening; and
contact of an interior surface of said collar with said splined sections during rotation of said collar in said first direction imparting a deflection of said splined sections toward a central axis of said axial passage, wherein a contact of said splined sections with said distal end of said support pole forms said removable compressive engagement therewith.

3. The trek pole engageable support apparatus of claim 2 additionally comprising:
movement of said collar in a first direction progressively further toward said second end of said support member increases a force of said removable compressive engagement.

4. The trek pole engageable support apparatus of claim 1 additionally comprising:
a plurality of said support members; and
said engagement at a first end of each of said support members to said support body being a pivoting engagement.

5. The trek pole engageable support apparatus of claim 2 additionally comprising:
a plurality of said support members; and
said engagement at a first end of each of said support members to said support body being a pivoting engagement.

6. The trek pole engageable support apparatus of claim 3 additionally comprising:
a plurality of said support members; and
said engagement at a first end of each of said support members to said support body being a pivoting engagement.

8. The trek pole engageable support apparatus of claim 4 wherein said plurality is three said support members.

9. The trek pole engageable support apparatus of claim 5 wherein said plurality is three said support members.

10. The trek pole engageable support apparatus of claim 6 wherein said plurality is three said support members.
